(19) United States
(12) Patent Application Publication
(10) Pub. No.: US 2022/0005393 A1
(43) Pub. Date: Jan. 6, 2022

(54) METHOD AND DEVICE FOR DETERMINING PIXEL COMPENSATION VALUE, ELECTRONIC DEVICE AND STORAGE MEDIUM

(71) Applicants: Chengdu BOE Optoelectronics Technology Co., Ltd., Chengdu, Sichuan (CN); BOE Technology Group Co., Ltd., Beijing (CN)

(72) Inventors: Kai YANG, Beijing (CN); Chengte LAI, Beijing (CN); Suncun LI, Beijing (CN)

(21) Appl. No.: 17/292,813

(22) PCT Filed: May 20, 2020
(86) PCT No.: PCT/CN2020/091281

§ 371 Date: May 11, 2021

(30) Foreign Application Priority Data
May 22, 2019 (CN) 201910430807.1

(51) Int. Cl. G09G 3/20

(52) U.S. Cl. CPC G09G 3/20; G09G 2360/16; G09G 2330/12; G09G 2320/0233; G09G 2320/0673

(57) ABSTRACT

The present disclosure provides a method and a device for determining a pixel compensation value, an electronic device and a storage medium. The method includes: enabling a pixel to display at three test gray scales respectively, and obtaining an actual luminosity of the pixel at each test gray scale; calculating compensation values of the pixel at the three test gray scales according to actual luminosities and standard luminosities of the pixel at the three test gray scales respectively, wherein the compensation value of the pixel at any gray scale is a gray scale which can enable the actual luminosity of the pixel to be equal to the standard luminosity of the pixel at the gray scale; calculating standard coefficients Gain1, Gain2 and Offset according to a specific formula; and calculating the compensation value y of the pixel at the gray scale x according to a specific formula.

### CROSS REFERENCE TO RELATED APPLICATIONS

The present application claims priority to Chinese patent application No. 201910430807.1 filed at Chinese Intellectual Property Office on May 22, 2019, the entire contents of which are incorporated herein by reference.

### TECHNICAL FIELD

The present disclosure relates to the field of display technology, and particularly relates to a method and a device for determining a pixel compensation value, an electronic device, and a storage medium.

### BACKGROUND

Due to the fluctuation of the manufacturing process, the properties of different pixels (or called sub-pixels) of the display panel are not completely the same. Therefore, actual display luminosity of different pixels differs at a same gray scale (a same data voltage), and thus luminosity non-uniformity (Mura defect) is caused.

### SUMMARY

An aspect of the present disclosure provides a method for determining a pixel compensation value, including: enabling a pixel to display at three test gray scales respectively, and obtaining an actual luminosity of the pixel at each test gray scale;

calculating compensation values of the pixel at the three test gray scales according to actual luminosities and standard luminosities of the pixel at the three test gray scales respectively, wherein the compensation value of the pixel at any gray scale is a gray scale which can enable the actual luminosity of the pixel to be equal to the standard luminosity of the pixel at the gray scale;

calculating standard coefficients Gain1, Gain2 and Offset according to a formula y′=x′*Gain1²+x′*Gain2+Offset, wherein x′ is the test gray scale, and y′ is the compensation value of the pixel at the test gray scale x′; and

calculating the compensation value y of the pixel at the gray scale x according to a formula y=(x*Gain1²+x*Gain2+Offset)*Ratio+x, where Ratio is an adjustment coefficient corresponding to the gray scale x.

In some implementations, the standard luminosity Lb of the pixel at any gray scale is calculated by a formula Lb=Lmax*(x/X)^{gamma}, where Lmax is a maximum theoretical luminosity of the pixel, x is the gray scale, X is a maximum gray scale, and gamma is a current gamma value.

In some implementations, the calculating the compensation values of the pixel at the three test gray scales respectively according to the actual luminosities and the standard luminosities of the pixel at the three test gray scales includes:

calculating a luminosity ratio coefficient C1 of the pixel at the test gray scale x′ according to a formula C1=Lb′/Ls′, where Lb′ is a standard luminosity of the pixel at the test gray scale x′, and Ls′ is the actual luminosity of the pixel at the test gray scale x′;

calculating a gray scale coefficient C2 of the pixel at the test gray scale x′ according to a formula C2=C1*(x′/X)^{gamma}, where X is a maximum gray scale, and gamma is a current gamma value; and

calculating the compensation value y′ of the pixel at the test gray scale x′ according to a formula y′=X*C2^{(1/gamma}).

In some implementations, the method for determining the pixel compensation value further includes: before the calculating the compensation value y of the pixel at the gray scale x according to the formula y=(x*Gain1²+x*Gain2+Offset)*Ratio+x, calculating an adjustment coefficient of the pixel at each of other gray scales by an interpolation method according to preset adjustment coefficients of the pixel at a plurality of node gray scales.

In some implementations, the node gray scales are more than 3 in number and are uniformly distributed in all the gray scales.

In some implementations, the method for determining the pixel compensation value further includes:

after the calculating the compensation value y of the pixel at the gray scale x according to the formula y=(x*Gain1²+x*Gain2+Offset)*Ratio+x,

enabling the pixel to display at a plurality of retest gray scales according to corresponding compensation values, respectively, and obtaining the actual luminosity of the pixel at each retest gray scale;

judging whether a difference between the actual luminosity and the standard luminosity of the pixel at each of the retest gray scales meets a preset standard or not;

if not, changing the adjustment coefficients of the pixel at the plurality of node gray scales, and returning to the calculating the adjustment coefficient of the pixel at each of other gray scales by the interpolation method according to preset adjustment coefficients of the pixel at the plurality of node gray scales.

An aspect of the present disclosure provides a device for determining a pixel compensation value, including:

a test circuit configured to enable a pixel to display at three test gray scales respectively and obtaining an actual luminosity of the pixel at each test gray scale respectively;

a first compensation value calculating circuit configured to respectively calculate the compensation values of the pixel at the three test gray scales according to actual luminosities and standard luminosities of the pixel at the three test gray scales, and the compensation value of the pixel at any gray scale is a gray scale which can enable the actual luminosity of the pixel to be equal to the standard luminosity of the pixel at the gray scale;

a standard coefficient calculating circuit configured to calculate standard coefficients Gain1, Gain2 and Offset according to a formula y′=x′*Gain1²+x′*Gain2+Offset, wherein x′ is the test gray scale, and y′ is the compensation value of the pixel at the test gray scale x′; and

a second compensation value calculating circuit configured to calculate the compensation value y of the pixel at the gray scale x according to a formula y=(x*Gain1²+x*Gain2+Offset)*Ratio+x, where Ratio is an adjustment coefficient corresponding to the gray scale x.

In some implementations, the first compensation value calculation circuit is specifically configured to:

calculate a luminosity ratio coefficient C1 of the pixel at the test gray scale x′ according to a formula C1=Lb′/Ls′, where Lb′ is a standard luminosity of the pixel at the test gray scale x′, and Ls′ is the actual luminosity of the pixel at the test gray scale x′;

calculate a gray scale coefficient C2 of the pixel at the test gray scale x′ according to a formula C2=C1*(x′/X)^{gamma}, where X is a maximum gray scale, and gamma is a current gamma value; and

calculate the compensation value y′ of the pixel at the test gray scale x′ according to a formula y′=X*C2^{(1/gamma)}.

In some implementations, the device for determining the pixel compensation value further includes:

an adjusting coefficient calculating circuit configured to calculate an adjustment coefficient of the pixel at each of other gray scales by an interpolation method according to preset adjustment coefficients of the pixel at a plurality of node gray scales.

In some implementations, the device for determining the pixel compensation value further includes a retest circuit configured to:

enable the pixel to display at a plurality of retest gray scales according to corresponding compensation values, respectively, and obtain the actual luminosity of the pixel at each retest gray scale;

judge whether a difference between the actual luminosity and the standard luminosity of the pixel at each of the retest gray scales meets a preset standard or not; and

If not, change the adjustment coefficients of the pixel at the plurality of node gray scales.

An aspect of the present disclosure provides an electronic device, including:

one or more processors;

a memory storing one or more programs which, when being executed by the one or more processors, cause the one or more processors to implement any of the above-described methods for determining the pixel compensation value.

An aspect of the present disclosure provides a computer-readable storage medium having stored thereon a computer program which, when being executed by a processor, is capable of performing any of the above-described methods for determining the pixel compensation value.

### DRAWINGS

FIG. 1 is a flow chart of a method for determining a pixel compensation value according to an embodiment of the present disclosure;

FIG. 2 is a block diagram of a device for determining a pixel compensation value according to an embodiment of the present disclosure;

FIG. 3 is a block diagram of a display device according to an embodiment of the present disclosure.

### DETAILED DESCRIPTION

In order that those skilled in the art will better understand the technical solutions of the present disclosure, the following detailed description is given with reference to the accompanying drawings and the specific embodiments.

It is to be understood that the specific embodiments and drawings described herein are merely used to explain the present disclosure, not to limit the present disclosure.

It is to be understood that the various embodiments and features of the embodiments in the present disclosure may be combined with each other without conflict.

It is to be understood that, for convenience of description, only portions related to the present disclosure are shown in the drawings of the present disclosure, and portions not related to the present disclosure are not shown in the drawings.

It is to be understood that each circuit and each device involved in the embodiments of the present disclosure may correspond to only one physical structure, may also be composed of multiple physical structures, or multiple circuits and multiple devices may also be integrated into one physical structure.

It is to be understood that, without conflict, the functions, steps, etc. marked in the flowchart and block diagrams of the present disclosure may occur in an order different from that marked in the drawings.

It is to be understood that the flowchart and block diagrams of the present disclosure illustrate the architecture, functionality, and operation of possible implementations of system, apparatus, device and method according to various embodiments of the present disclosure. Each block in the flowchart or block diagrams can represent a circuit, device, program segment and code, which contains executable instructions for realizing specified functions. Furthermore, each block or combination of blocks in the block diagrams and the flowchart may be implemented by hardware-based systems that perform the specified functions or by a combination of hardware and computer instructions.

It is to be understood that the circuits and devices involved in the embodiments of the present disclosure may be implemented by software, and may also be implemented by hardware, for example, the circuits and devices may be located in a processor.

Approaches for solving Mura defect (De-Mura) in the related art may include: before leaving a factory, a display panel is enabled to display at a certain gray scale, actual luminosity of each pixel is collected by a CCD (charge coupled device) camera, a pixel with a difference between the actual luminosity and a standard luminosity (namely the luminosity of the pixel at the gray scale theoretically) is found out to be the pixel with Mura, and a compensation value is set for the pixel with Mura according to the difference; when the pixel with Mura is to be displayed at the gray scale (e.g. 100 gray scale), the pixel with Mura is actually displayed according to the compensation value (e.g. 105 gray scale) so that the actual luminosity (the actual luminosity at 105 gray scale) is equal to the standard luminosity (the luminosity theoretically should be at 100 gray scale).

Due to time limitation, compensation values cannot be directly measured at each gray scale in the above manner, but only 2 or 3 specific gray scales are selected as test gray scales, the compensation values of the test gray scales are measured, and the compensation values of other gray scales are calculated according to the compensation values of the test gray scales. However, the compensation value obtained by the conventional calculation method is not accurate, so that the difference between the actual luminosity and the standard luminosity of the pixel is possibly still large when the pixel displays at other gray scales according to the compensation value, and the Mura defect cannot be effectively eliminated.

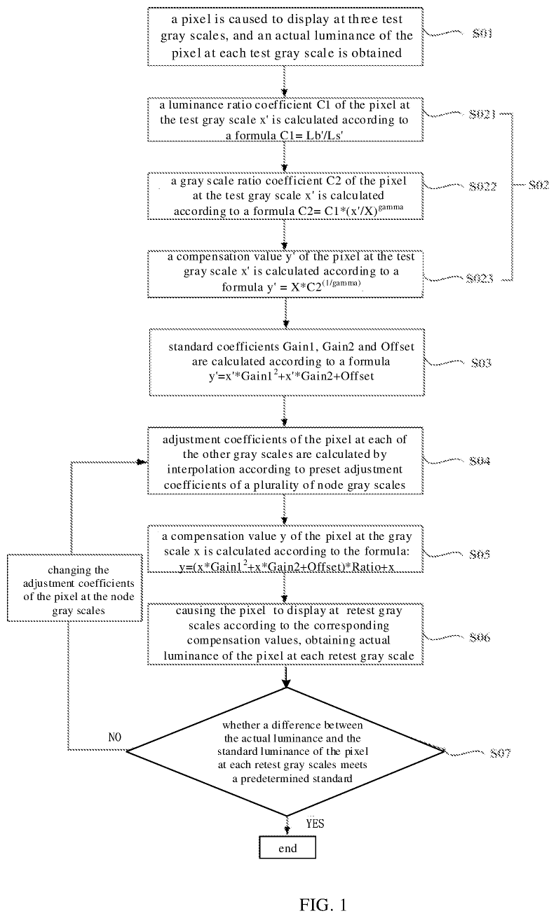

Referring to FIG. 1, an embodiment of the present disclosure provides a method for determining a pixel compensation value.

The method of the present embodiment is used for determining the compensation value of the pixel (or called sub-pixel) at each gray scale, so that the pixel can actually display according to the compensation value (such as the gray scale B) of the gray scale A when the pixel is to display at the gray scale A, and further, the actual luminosity of the pixel is ensured to be equal to the standard luminosity (namely the luminosity of the pixel theoretically should be at the gray scale A), thereby eliminating the Mura defect.

Certainly, the display panel actually includes many pixels, and the compensation value of each pixel can be determined separately according to the method of the present embodiment, but the process of determining the compensation value for only one pixel in the present embodiment is described as an example.

Specifically, the method for determining the pixel compensation value of the present embodiment includes following steps S01 to S07.

In step S01, a pixel is caused to display at three test gray scales, and an actual luminosity of the pixel at each test gray scale is obtained.

That is, the pixel respectively displays at three preset test gray scales, and during each display, an image of the pixel is collected by a CCD camera or the like, so as to respectively obtain the actual luminosities of the pixel at the three test gray scales.

The test gray scales are not particularly specified and may be selected empirically, but generally, the three test gray scales should be distributed relatively uniformly in all gray scales, for example, for a display panel having 256 gray scales (i.e., 0-255 gray scales), the three test gray scales may be a 32 gray scale, a 96 gray scale, or a 192 gray scale.

Certainly, since the display panel actually includes many pixels, in the present step, the display panel can actually display at the test gray scale, and the image of the display panel can be obtained, so as to analyze the actual luminosity of each pixel.

In step S02, compensation values of the pixel at the three test gray scales are calculated according to the actual luminosities and standard luminosities of the pixel at the three test gray scales. In the present embodiment, the compensation value of the pixel at any gray scale is a gray scale that can enable the actual luminosity of the pixel to be equal to the standard luminosity.

The standard luminosity of the pixel at a certain gray scale refers to: the luminosity that the pixel theoretically should have at the corresponding gray scale. Therefore, if the actual luminosity of the pixel at the certain test gray scale is different from the standard luminosity (in other words, a difference between the actual luminosity and the standard luminosity exceeds a threshold), it indicates that the pixel has Mura defect, so the compensation value of the pixel at the test gray scale needs to be calculated according to the difference between the actual luminosity and the standard luminosity. The compensation value of the pixel at the certain gray scale refers to: when the pixel is to display at a corresponding gray scale, the pixel should actually displays according to a gray scale of the compensation value, so that the actual luminosity of the pixel is equal to the standard luminosity of the corresponding gray scale.

Certainly, since there are three test gray scales, for each pixel, a corresponding compensation value is calculated at each test gray scale, i.e., there are three calculated compensation values.

Certainly, if the actual luminosities of the pixel at the three test gray scales are the same as the corresponding standard luminosities (or the difference between each actual luminosity and the standard luminosity corresponding thereto is smaller than the threshold), the pixel can be considered to have no Mura defect, and no compensation value needs to be set for the pixel, that is, no subsequent operation is needed; alternatively, it can be considered that the compensation value of the pixel without Mura defect at any gray scale is directly equal to the corresponding gray scale.

In some implementations, the standard luminosity Lb of the pixel at any gray scale can be calculated by the formula Lb=Lmax*(x′/X)^{gamma}, where Lmax is a maximum theoretical luminosity of the pixel, x′ is the gray scale, X is a maximum gray scale, and gamma is a current gamma value.

That is, a maximum luminosity (e.g., luminosity at 255 gray scale) that can be theoretically achieved by the pixel and the gamma value adopted by the current display panel can be used to calculate the luminosity (i.e., standard luminosity) that the pixel should have at each gray scale (e.g., each test gray scale) according to the gamma curve by the above formula.

Certainly, it is also feasible if the standard luminosity of the pixel at each gray scale is preset.

Specifically, the step (S02) may include following steps S021 to S023.

In step S021, a luminosity ratio coefficient C1 of the pixel at the test gray scale x′ is calculated according to a formula C1=Lb′/Ls′, where Lb′ is the standard luminosity of the pixel at the test gray scale x′, and Ls′ is the actual luminosity of the pixel at the test gray scale x′.

Specifically, a ratio of the standard luminosity that the pixel should have to the actual luminosity of the pixel at the test gray scale is calculated according to the formula. For example, assuming that the standard luminosity of the pixel at the 32 gray scale is 3.1nit and the actual luminosity of the pixel is 2nit, C1=3.1/2=1.55.

In step S022, a gray scale ratio coefficient C2of the pixel at the test gray scale x′ is calculated according to a formula C2=C1*(x′/X)^{gamma}, where X is the maximum gray scale and gamma is the current gamma value.

The gray scale ratio coefficient C2 of the pixel at each test gray scale is calculated according to the above formula and the luminosity ratio coefficient C1. For example, if the gamma value currently adopted by the display panel is 2.2 and the maximum gray scale is 255, the above gray scale coefficient of the pixel at the 32 gray scale (test gray scale) is: C2=1.55* (32/255)^{2.2}=0.01612.

In step S023, a compensation value y′ of the pixel at the test gray scale x′ is calculated according to a formula y′=X*C2^{(1/gamma)}.

The compensation value at the test gray scale is calculated according to the above formula based on C2 above. For example, for the above pixel, the compensation value at the gray scale of 32 is y′=255 *0.01612^{(1/2.2)}=39; that is, for the pixel, when it is to display at the gray scale of 32, it should be actually supplied with a data voltage corresponding to the 39 gray scale, so that the actual luminosity of the pixel at the data voltage is equal to 3.1nit, which is the standard luminosity of the 32 gray scale.

In step S03, standard coefficients Gain1, Gain2 and Offset are calculated according to a formula y′=x′*Gain1²+x′*Gain2+Offset, where x′ is the test gray scale and y ‘is the compensation value of the pixel at the test gray scale x’.

As mentioned above, there are three test gray scales, and thus there are three corresponding test gray scales x′ and three corresponding compensation values y′. Therefore, three equations can be formed according to the above formula, which can constitute one equation set, and since the number of unknowns (Gain1, Gain2, Offset) and the number of equations in the equation set are all three, the above standard coefficients Gain1, Gain2, Offset are necessarily calculable.

In step S04, in some implementations, adjustment coefficients of the pixel at each of the other gray scales are calculated by interpolation according to preset adjustment coefficients of a plurality of node gray scales.

That is, for some specific gray scales (node gray scales), adjustment coefficients are set for the specific gray scales, and then, according to the adjustment coefficients for the specific gray scales, adjustment coefficients of other gray scales are calculated, so that each gray scale has a corresponding adjustment coefficient Ratio.

In some implementations, the node gray scales are more than 3 in number and are uniformly distributed among all gray scales.

That is, the number of the node gray scales should be greater than the number of the test gray scales, so as to improve the accuracy of the compensation value calculation; and the distribution of the node gray scales among all the gray scales should be relatively uniform, i.e., the difference in the number of the gray scales between adjacent node gray scales should be as small as possible. For example, if a total number of gray scales is 256 (i.e., 0 to 255 gray scales) and a total number of node gray scales is 17, the node gray scales may be 0 gray scale, 16 gray scale, 32 gray scale, 48 gray scale, 64 gray scale, 80 gray scale, 96 gray scale, 112 gray scale, 128 gray scale, 144 gray scale, 160 gray scale, 176 gray scale, 192 gray scale, 208 gray scale, 224 gray scale, 240 gray scale, 255 gray scale; except that the number of the gray scales between the 240 gray scale and the 255 gray scale is 14, the number of the gray scales between any adjacent node gray scales is 15.

Interpolation method refers to that adjustment coefficients of any two adjacent node gray scales and other gray scales between them are linearly distributed. For example, if the adjustment coefficient of the above 0 gray scale is Ratio_0 and the adjustment coefficient of the 16 gray scale is Ratio_16, then:

the adjustment coefficient of the 1 gray scale is Ratio_1=Ratio_0+(Ratio_16-Ratio_0)* 1/16;

the adjustment coefficient of the 2 gray scale is Ratio_2=Ratio_0+(Ratio_16−Ratio_0)* 2/16;

the adjustment coefficient of the 3 gray scale is Ratio_3=Ratio_0+(Ratio_16−-Ratio_0) 3/16;

. . . ... and so on; the adjustment coefficient of the 15 gray scale is Ratio_15=Ratio_0+(Ratio_16-Ratio_0)*15/16.

Certainly, the adjustment coefficients of other gray scales between the other node gray scales can also be determined in the above manner, and will not be described in detail herein.

Certainly, it is also possible to directly set the adjustment coefficients for all gray scales, so the step (S04) is optional.

Certainly, the above adjustment coefficients should be set to ensure that the compensation values calculated according to the subsequent step S05 are the same as the compensation values calculated in the above step S02 for the three test gray scales, i.e., at least part of the adjustment coefficients are set according to the known compensation values of the test gray scales.

According to above method, the adjustment coefficient for each gray scale can be calculated as long as the adjustment coefficients are set for part of the node gray scales, so that the compensation value for each gray scale is obtained, therefore, on one hand, low storage capacity and low calculation amount are required, so that the method is easy to be realized; on the other hand, the adjustment coefficients can be flexibly set according to the actual situation so as to more accurately obtain the compensation value for each gray scale and realize better display effect.

In step S05, a compensation value y of the pixel at the gray scale x is calculated according to the formula: y.(x*Gain1²+x*Gain2+Offset)*Ratio+x, where Ratio is the adjustment coefficient corresponding to the gray scale x.

After the adjustment coefficient Ratio for each gray scale is obtained (or the adjustment coefficient Ratio for each gray scale is directly preset), the compensation value y corresponding to any gray scale x is calculated according to the above formula.

According to the method for determining the pixel compensation value, the compensation value of the pixel at any gray scale can be obtained through specific operation, and the calculation method of the compensation value is different from the existing method and is more reasonable, so that the obtained compensation value is more accurate, a better display effect can be obtained when displaying according to the compensation value, and Mura defect can be eliminated.

In step S06, in some implementations, causing the pixel respectively to display at a plurality of retest gray scales according to the corresponding compensation values, and actual luminosity of the pixel at each retest gray scale is obtained.

After the compensation values of the pixel at the respective gray scales are obtained, the pixel is enabled to display at part of specific gray scales (retest gray scales) according to the corresponding compensation values, and the actual luminosity of the pixel when the pixel displaying according to the compensation value is acquired through a CCD camera and the like.

In step S07, in some implementations, it is judged whether a difference between the actual luminosity and the standard luminosity of the pixel at each of the plurality of retest gray scales meets a predetermined standard, if so, the method ends, if not, the adjustment coefficients of the pixel at the node gray scales are changed, and the process returns to the step SO4.

That is, whether the display effect when displaying according to the current compensation value is qualified (for example, it is judged whether a maximum difference between the actual luminosity and the standard luminosity is smaller than the threshold) is judged according to the actual luminosity of the pixel when displaying according to the compensation value.

If the display effect is qualified, it indicates that the currently determined compensation value is reasonable, the process of determining the pixel compensation value can be ended.

If the display effect is not qualified, it indicates that the current compensation value is not reasonable, so the compensation value needs to be recalculated, but since the process of calculating Gainl, Gain2 and Offset is standard, the unreasonable result is usually caused by unreasonable value of the adjustment coefficient Ratio. Therefore, when the difference between the actual luminosity and the standard luminosity does not meet the predetermined standard, the adjustment coefficients of the node gray scales can be reset, and the process returns to step SO4, the adjustment coefficients of all gray scales are recalculated according to the reset adjustment coefficients, and the compensation values of the gray scales are recalculated.

The above method can continuously adjust in a loop way to obtain the most appropriate adjustment coefficient Ratio, further obtain a more reasonable compensation value, and further improve the accuracy of the compensation value.

Certainly, if it can be ensured that the value of the adjustment coefficient Ratio is reasonable, the above step of performing the loop adjustment of the adjustment coefficient is not needed (i.e., the steps S06 and S07 are not performed), and these steps are optional.

For example, for a batch of display panels, the above steps S06 and S07 can be performed only when determining the pixel compensation value for the first display panel to obtain a set of adjustment coefficients corresponding to the node gray scales; thus, when determining the pixel compensation values for other display panels in the batch subsequently, the corresponding adjustment coefficients can be directly used without performing the steps S06 and S07.

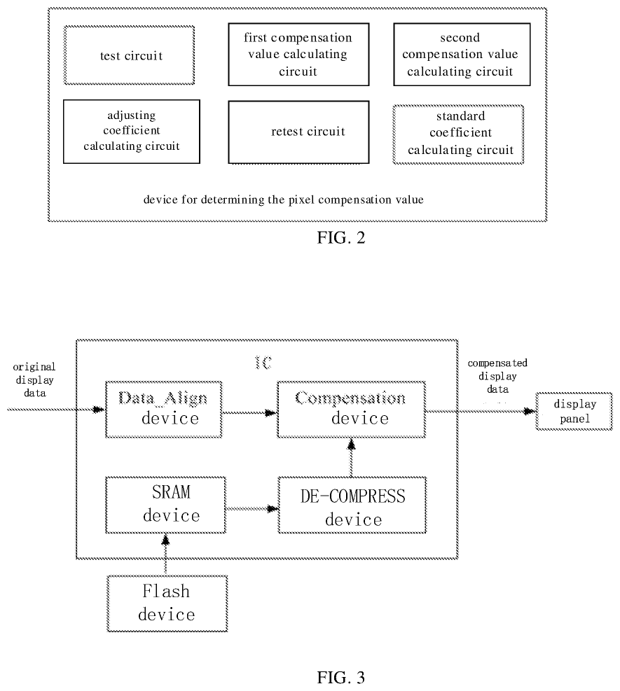

Referring to FIG. 2, an embodiment of the present disclosure provides a device for determining a pixel compensation value, including:

a test circuit configured to enable a pixel to display at three test gray scales respectively and obtain actual luminosity of the pixel at each test gray scale;

a first compensation value calculating circuit configured to respectively calculate compensation values of the pixel at the three test gray scales according to actual luminosities and standard luminosities of the pixel at the three test gray scales, the compensation value of the pixel at any gray scale is a gray scale which can enable the actual luminosity of the pixel to be equal to the standard luminosity of the gray scale;

a standard coefficient calculating circuit configured to calculate standard coefficients Gain1, Gain2 and Offset according to a formula y′=x′*Gain1²+x′*Gain2+Offset, where x′ is a test gray scale, and y′ is the compensation value of the pixel at the test gray scale x′; and a second compensation value calculating circuit configured to calculate the compensation value y of the pixel at the gray scale x according to a formula y=(x*Gain1²+x*Gain2+Offset)*Ratio+x, where Ratio is an adjustment coefficient corresponding to the gray scale x.

In some implementations, the first compensation value calculating circuit is specifically configured to:

calculate a luminosity ratio coefficient C1 of the pixel at the test gray scale x′ according to a formula C1=Lb′/Ls′, where Lb′ is the standard luminosity of the pixel at the test gray scale x′, and Ls′ is the actual luminosity of the pixel at the test gray scale x′;

calculate a gray scale ratio coefficient C2 of the pixel at the test gray scale x′ according to a formula C2=C1*(x′/X)^{gamma}, where X is a maximum gray scale, and gamma is a current gamma value; and

calculate the compensation value y′ of the pixel at the test gray scale x′ according to a formula y′=X*C2^{(1/gamma)}.

In some implementations, the device for determining the pixel compensation value further includes:

an adjusting coefficient calculating circuit configured to calculate the adjusting coefficient of the pixel at each of other gray scales by an interpolation method according to preset adjusting coefficients of the pixel at a plurality of node gray scales.

In some implementations, the device for determining the pixel compensation value further includes a retest circuit configured to:

respectively enable the pixel to display at a plurality of retest gray scales according to corresponding compensation values, respectively, and obtaining the actual luminosity of the pixel at each of the retest gray scales;

judge whether the difference between the actual luminosity and the standard luminosity of the pixel at each of the plurality of the retest gray scales meets a preset standard or not; and

if not, change the adjustment coefficients of the pixel at the node gray scales.

The device for determining the pixel compensation value of the present embodiment can perform the above method for determining the pixel compensation value, so as to obtain a more reasonable compensation value, so as to improve the display effect of the display panel.

The circuits in the above device for determining the pixel compensation value may include a storage medium (e.g., a hard disk) having a capability of storing data, a processor (e.g., a CPU) having a capability of executing software programs, a device (e.g., a CCD camera) having a physical function, a device (e.g., a burning device) having a capability of outputting data to a display device, and the like, which are not described in detail herein.

Referring to FIG. 3, an embodiment of the present disclosure provides a display device in which a compensation value obtained according to the above method is stored or a calculating circuit capable of determining the compensation value in the above manner is provided.

In an actual display device, the display panel can display according to the above compensation value, so that the display effect is improved.

For example, the structure of the display device may refer to FIG. 3, the compensation value is stored in a Flash (Flash memory) module; a Data_Align module is configured to receive original display data (i.e., the gray scales, that the pixels should have, obtained according to an image to be displayed), and determine the gray scales for the pixels, and send them to a compensation module; a SRAM (static random access memory) module reads the compensation values from the Flash module, decompresses the compensation values by a DE-COMPRESS (decompression) module and then sent them to the compensation module; the compensation module obtains the gray scales that each pixel should actually display based on the compensation values, that is, generates compensation display data, and sends the compensation display data to the display panel for displaying.

The Data_Align module, the compensation module, the SRAM module, the DE-COMPRESS module, etc., may be independent processors, or may be integrated in a chip (IC).

In some implementations, only the above adjustment coefficients Ratio and the compensation values y′ of the test pixels may actually be stored in the display device, and the compensation value at the time of actual display of the pixel is calculated by the compensation module at each display according to the above formula.

Specifically, the display device may be any product or component having a display function, such as a liquid crystal display device (LCD), an Organic Light Emitting Diode (OLED) display device, electronic paper, a mobile phone, a tablet computer, a television, a display, a notebook computer, a digital photo frame, and a navigator.

An embodiment of the present disclosure provides an electronic device, including:

one or more processors;

a memory storing one or more programs which, when executed by the one or more processors, causes the one or more processors to implement any one of the above-mentioned methods for determining the pixel compensation value.

An embodiment of the present disclosure provides a computer-readable medium, on which a computer program is stored, and the computer program, when being executed by a processor, can implement any one of the above-mentioned methods for determining the pixel compensation value.

The computer-readable medium may be included in the apparatuses, devices, and systems of the present disclosure, or may exist separately.

The computer-readable storage medium may be any tangible medium that can contain or store a program, and may be an electronic, magnetic, optical, electromagnetic, infrared, or semiconductor system, apparatus, or device, more specific examples of which include but are not limited to: an electrical connection having one or more wires, a portable computer diskette, a hard disk, an optical fiber, a Random Access Memory (RAM), a read-only memory (ROM), an erasable programmable read-only memory (EPROM or flash memory), a portable compact disc read-only memory (CD-ROM), an optical storage device, a magnetic storage device, or any suitable combination thereof.

The computer-readable storage medium may also include a data signal transmitted in baseband or as part of a carrier wave, in which a computer-readable program code is carried, and specific examples thereof include, but are not limited to, an electromagnetic signal, an optical signal, or any suitable combination thereof.

It will be understood that the above embodiments are merely exemplary embodiments employed to illustrate the principles of the present disclosure, and the present disclosure is not limited thereto. It will be apparent to those skilled in the art that various changes and modifications can be made therein without departing from the spirit and scope of the present disclosure, and these changes and modifications are to be considered within the scope of the present disclosure.

1. A method for determining a pixel compensation value, comprising:
enabling a pixel to display at three test gray scales respectively, and obtaining an actual luminosity of the pixel at each test gray scale;
calculating compensation values of the pixel at the three test gray scales according to actual luminosities and standard luminosities of the pixel at the three test gray scales respectively, wherein the compensation value of the pixel at any gray scale is a gray scale which can enable the actual luminosity of the pixel to be equal to the standard luminosity of the pixel at the gray scale;
calculating standard coefficients Gain 1, Gain2 and Offset according to a formula y′=x′*Gain12+x′*Gain2+Offset, wherein x′ is the test gray scale, and y′ is the compensation value of the pixel at the test gray scale x′; and
calculating the compensation value y of the pixel at the gray scale x according to a formula y=(x*Gain12+x*Gain2+Offset)*Ratio+x, wherein Ratio is an adjustment coefficient corresponding to the gray scale x.

2. The method for determining the pixel compensation value according to claim 1, the standard luminosity Lb of the pixel at any gray scale is calculated by a formula Lb=Lmax*(x/X)gamma, wherein Lmax is a maximum theoretical luminosity of the pixel, x is the gray scale, X is a maximum gray scale, and gamma is a current gamma value.

3. The method for determining the pixel compensation value according to claim 1, wherein the calculating the compensation values of the pixel at the three test gray scales respectively according to the actual luminosities and the standard luminosities of the pixel at the three test gray scales comprises:
calculating a luminosity ratio coefficient C1 of the pixel at the test gray scale x′ according to a formula C1=Lb′/Ls′, wherein Lb′ is a standard luminosity of the pixel at the test gray scale x′, and Ls′ is the actual luminosity of the pixel at the test gray scale x′;
calculating a gray scale coefficient C2 of the pixel at the test gray scale x′ according to a formula C2=C1*(x′/X)gamma, wherein X is a maximum gray scale, and gamma is a current gamma value; and
calculating the compensation value y′ of the pixel at the test gray scale x′ according to a formula y′=X*C2(1/gamma).

4. The method for determining the pixel compensation value according to claim 1, further comprising:
before the calculating the compensation value y of the pixel at the gray scale x according to a formula y=(x*Gain12+x*Gain2+Offset)*Ratio+x, calculating an adjustment coefficient of the pixel at each of other gray scales by an interpolation method according to preset adjustment coefficients of the pixel at a plurality of node gray scales.

5. The method for determining the pixel compensation value according to claim 4, wherein
the node gray scales are more than 3 in number and are uniformly distributed in all the gray scales.

6. The method for determining the pixel compensation value according to claim 4, further comprising:
after the calculating the compensation value y of the pixel at the gray scale x according to the formula y=(x*Gain12+x*Gain2+Offset)*Ratio+x,
enabling the pixel to display at a plurality of retest gray scales according to corresponding compensation values, respectively, and obtaining the actual luminosity of the pixel at each retest gray scale;
judging whether a difference between the actual luminosity and the standard luminosity of the pixel at each of the retest gray scales meets a preset standard or not;
if not, changing the adjustment coefficients of the pixel at the plurality of node gray scales, and returning to the calculating the adjustment coefficient of the pixel at each of other gray scales by the interpolation method according to preset adjustment coefficients of the pixel at the plurality of node gray scales.

7. A device for determining a pixel compensation value, comprising:
a test circuit configured to enable a pixel to display at three test gray scales respectively and obtaining an actual luminosity of the pixel at each test gray scale;
a first compensation value calculating circuit configured to respectively calculate the compensation values of the pixel at the three test gray scales according to actual luminosities and standard luminosities of the pixel at the three test gray scales, and the compensation value of the pixel at any gray scale is a gray scale which can enable the actual luminosity of the pixel to be equal to the standard luminosity of the pixel at the gray scale;
a standard coefficient calculating circuit configured to calculate standard coefficients Gain1, Gain2 and Offset according to a formula y′=x′*Gain12+x′*Gain2+Offset, wherein x′ is the test gray scale, and y′ is the compensation value of the pixel at the test gray scale x′; and
a second compensation value calculating circuit configured to calculate the compensation value y of the pixel at the gray scale x according to a formula y=(x*Gain12+x*Gain2+Offset)*Ratio+x, wherein Ratio is an adjustment coefficient corresponding to the gray scale x.

8. The device for determining the pixel compensation value according to claim 7, wherein the first compensation value calculating circuit is configured to:
calculate a luminosity ratio coefficient C1 of the pixel at the test gray scale x′ according to a formula C1=Lb′/Ls′, wherein Lb′ is a standard luminosity of the pixel at the test gray scale x′, and Ls′ is the actual luminosity of the pixel at the test gray scale x′;
calculate a gray scale coefficient C2 of the pixel at the test gray scale x′ according to a formula C2=C1*(x′/X)gamma, wherein X is a maximum gray scale, and gamma is a current gamma value; and
calculate the compensation value y′ of the pixel at the test gray scale x′ according to a formula y′=X*C2(1/gamma).

9. The device for determining the pixel compensation value according to claim 7, further comprising:
an adjusting coefficient calculating circuit configured to calculate an adjustment coefficient of the pixel at each of other gray scales by an interpolation method according to preset adjustment coefficients of the pixel at a plurality of node gray scales.

10. The device for determining the pixel compensation value according to claim 9, further comprising a retest circuit configured to:
enable the pixel to display at a plurality of retest gray scales according to corresponding compensation values, respectively, and obtain the actual luminosity of the pixel at each retest gray scale;
judge whether a difference between the actual luminosity and the standard luminosity of the pixel at each of the retest gray scales meets a preset standard or not; and
if not, change the adjustment coefficients of the pixel at the plurality of node gray scales.

11. An electronic device, comprising:
one or more processors;
a memory storing one or more programs which, when being executed by the one or more processors, cause the one or more processors to implement the method for determining the pixel compensation value according to claim 1.

12. A computer-readable storage medium having stored thereon a computer program, wherein,
the computer program, when being executed by a processor, is capable of implementing the method for determining the pixel compensation value according to claim 1.

13. An electronic device, comprising:
one or more processors;
a memory storing one or more programs which, when being executed by the one or more processors, cause the one or more processors to implement the method for determining the pixel compensation value according to claim 2.

14. An electronic device, comprising:
one or more processors;
a memory storing one or more programs which, when being executed by the one or more processors, cause the one or more processors to implement the method for determining the pixel compensation value according to claim 3.

15. An electronic device, comprising:
one or more processors;
a memory storing one or more programs which, when being executed by the one or more processors, cause the one or more processors to implement the method for determining the pixel compensation value according to claim 4.

16. A computer-readable storage medium having stored thereon a computer program, wherein,
the computer program, when being executed by a processor, is capable of implementing the method for determining the pixel compensation value according to claim 5.

17. A computer-readable storage medium having stored thereon a computer program, wherein,
the computer program, when being executed by a processor, is capable of implementing the method for determining the pixel compensation value according to claim 2.

18. A computer-readable storage medium having stored thereon a computer program, wherein,
the computer program, when being executed by a processor, is capable of implementing the method for determining the pixel compensation value according to claim 3.

19. A computer-readable storage medium having stored thereon a computer program, wherein,
the computer program, when being executed by a processor, is capable of implementing the method for determining the pixel compensation value according to claim 4.

20. A computer-readable storage medium having stored thereon a computer program, wherein,
the computer program, when being executed by a processor, is capable of implementing the method for determining the pixel compensation value according to claim 5.
